(19) United States
(12) Patent Application Publication
(10) Pub. No.: US 2011/0134002 A1
(43) Pub. Date: Jun. 9, 2011

(54) Capacity loaded planar antenna with short stubs

(76) Inventors: Masaki Suto, Tokyo (JP); Ryoji Matsubara, Yokohama (JP); Naobumi Michishita, Tsukuba (JP)

(21) Appl. No.: 12/926,532

(22) Filed: Nov. 23, 2010

Related U.S. Application Data
(63) Continuation of application No. PCT/JP2009/002310, filed on May 26, 2009.

(30) Foreign Application Priority Data
May 28, 2008 (JP) 2008-139617

(51) Int. Cl. H01Q 1/48

(52) U.S. Cl. 343/722

(57) ABSTRACT

Provided is a capacity loaded planar antenna with short stubs that can be brought to a small size and a low profile, achieves wider bandwidth, and can be tuned to multiple frequencies. A capacity loaded planar antenna with short stubs that has a simple structure and can be easily manufactured includes a base plate, an antenna element disposed so as to be parallel to the base plate, a plurality of short stubs that connect the antenna element to the base plate, and a side wall formed on the end of the base plate. The capacity loaded planar antenna achieves wider bandwidth with the small size and low profiled, can be tuned to multiple frequencies by adjusting the length of the short stubs, and uses plate-shaped foldable short stubs that are integrated with the antenna element.

This is a Continuation of PCT/JP2009/002310 filed May 26, 2009 and published in Japanese, which has a priority of Japanese no. 2008-139617 filed May 28, 2008, hereby incorporated by reference.

### BACKGROUND OF THE INVENTION

1. Field of the Invention

The present invention relates to a small-sized antenna used in a weak electric field area of a base station antenna for mobile communication and more particularly, it relates to a capacity loaded planar antenna with short stubs which can achieve a wider bandwidth without changing a size of a base plate.

2. Description of the Related Art

In an indoor transponder for mobile communication installed on a ceiling or the like to be used, an omnidirectional, low-posture and small-sized wideband antenna is used.

In a capacity loaded monopole antenna obtained by lowering the posture of an omnidirectional monopole antenna, a plurality of posts can be arranged to match with a power supply line.

[Constitution of Conventional Capacity Loaded Planar Antenna: FIG. 12]

A constitution of a conventional capacity loaded planar antenna will be described with reference to FIG. 12. FIG. 12 is a schematic constitution diagram of the conventional capacity loaded planar antenna.

As shown in FIG. 12, the conventional capacity loaded planar antenna comprises an antenna element 10, a base plate 20, a support plate 30 and posts 40.

The antenna element 10 has a disc-like shape smaller than the base plate 20, and is installed in parallel with the base plate 20.

The base plate 20 includes the antenna element 10 fixed thereto via the support plate 30, and further the antenna element 10 is connected to the base plate 20 by the plurality of posts 40.

[Conventional VSWR: FIG. 13]

A voltage standing wave ratio (VSWR) in the constitution of the conventional capacity loaded planar antenna is shown in FIG. 13. FIG. 13 is a diagram showing conventional VSWR characteristics.

The VSWR is a ratio between crests and bottoms of a voltage amplitude distribution occurring along a transmission path where a reflected wave is generated owing to impedance mismatch.

As to the VSWR characteristics in the conventional constitution, as shown in FIG. 13, when the base plate 20 has a size (a diameter) of, for example, Dd=160 mm, a bandwidth of VSWR<1.5 is 5.6%, which turns out to be a narrow band.

Moreover, when a length ss of the posts 40 is ss=14 mm, the bandwidth of VSWR<1.5 is 2.6%, which turns out to be a narrow band.

[Conventional Vertical Plane Radiation Directivity: FIG. 14]

A vertical plane radiation directivity in the conventional constitution is shown in FIG. 14. FIG. 14 is a diagram showing the vertical plane radiation directivities at 1.9 GHz (FIG. 14A), 2.0 GHz (FIG. 14B), 2.1 GHz and 2.2 GHz (FIG. 14D).

[Conventional Horizontal Plane Radiation Directivity: FIG. 15]

A horizontal plane radiation directivity in the conventional constitution is shown in FIG. 15. FIG. 15 is a diagram showing the horizontal plane radiation directivities at 1.9 GHz (FIG. 15A), 2.0 GHz (FIG. 15B), 2.1 GHz (FIG. 15C) and 2.2 GHz (FIG. 15D).

Examples of a prior art concerning a low posture type capacity loaded dielectric monopole antenna include Japanese Patent Application Laid-Open No. 2003-229714 (Patent Document 1).

Patent Document 1 discloses a planar antenna where a structure which connects a capacitive electrode to a ground electrode and which abuts on a power supply pin can be simplified to facilitate processing and handling.

[Patent Document 1] Japanese Patent Application Laid-Open No. 2003-229714

### SUMMARY OF THE INVENTION

However, in the above conventional wideband antenna, to decrease an installation area of the antenna, a base plate needs to be small-sized, and the antenna needs to have a low posture, but to match with a power supply line over a wide bandwidth, the size of the base plate has to be changed, and the antenna needs to be tuned to a plurality of frequencies, which causes a problem that the constitution becomes complicated.

The present invention has been developed in view of the above situation, and an object thereof is to provide a capacity loaded planar antenna with short stubs which can acquire a small size and a low posture, can realize a wider bandwidth and can be tuned to a plurality of frequencies.

To solve the above problem of the conventional example, according to the present invention, there is provided a capacity loaded planar antenna with short stubs, comprising: a base plate; an antenna element disposed in parallel with the base plate; a plurality of short stubs which connect the antenna element to the base plate; and a side wall formed along the end portion of the base plate, which produces an effect that it is possible to acquire a small size and a low posture and realize a wider bandwidth.

According to the present invention, in the above capacity loaded planar antenna with the short stubs, a length of the short stubs is varied to vary a resonance frequency, which produces an effect that the antenna can be tuned to a plurality of frequencies.

According to the present invention, in the above capacity loaded planar antenna with the short stubs, the short stubs are formed integrally with the antenna element, and have a foldable plate-like shape, which produces an effect that the constitution can be simplified to facilitate manufacturing.

### BRIEF DESCRIPTION OF THE DRAWINGS

FIG. 1 is a schematic constitution diagram of a capacity loaded planar antenna with short stubs according to an embodiment of the present invention;

FIG. 2A is a plan view, and FIG. 2B is a side view;

FIG. 3 is a diagram showing a vertical plane radiation directivity of the present antenna;

FIG. 4 is a diagram showing a horizontal plane radiation directivity of the present antenna;

FIG. 5 is a diagram showing a bandwidth of VSWR<1.5 when a height of a side wall varies;

FIG. 6 is a diagram showing a VSWR when a length of short stubs can be varied;

FIG. 7 is a diagram showing three examples of a constitution of the short stubs;

FIG. 8 is a diagram showing a bandwidth of VSWR<1.5 when the length of the short stubs can be varied;

FIG. 9 is a diagram showing a resonance frequency when the length of the short stubs can be varied;

FIG. 10 is a diagram showing another shape 1 of the short stubs;

FIG. 11 is a diagram showing still another shape 2 of the short stubs;

FIG. 12 is a schematic constitution diagram of a conventional capacity loaded planar antenna;

FIG. 13 is a diagram showing conventional VSWR characteristics;

FIG. 14 is a diagram showing a conventional vertical plane radiation directivity; and

FIG. 15 is a diagram showing a conventional horizontal plane radiation directivity.

### DESCRIPTION OF REFERENCE NUMERALS

10 . . . antenna element, 20 . . . base plate, 30 . . . support plate, 40 . . . post, 50 . . . side wall, 60 . . . short pin, and 60′ . . . plate-like short stub.

### DESCRIPTION OF THE PREFERRED EMBODIMENT

An embodiment of the present invention will be described with reference to the drawings.

### Summary of Embodiment

A capacity loaded planar antenna with short stubs according to the embodiment of the present invention comprises a base plate, an antenna element, a plurality of short stubs which connect the antenna element to the base plate, and a side wall formed along the end portion of the base plate, which can acquire a small size and a low posture and realize a wider bandwidth.

Moreover, according to the capacity loaded planar antenna with the short stubs of the embodiment of the present invention, in the above constitution, a length of the short stubs can be varied, a resonance frequency can be varied and the antenna can be tuned to a plurality of frequencies.

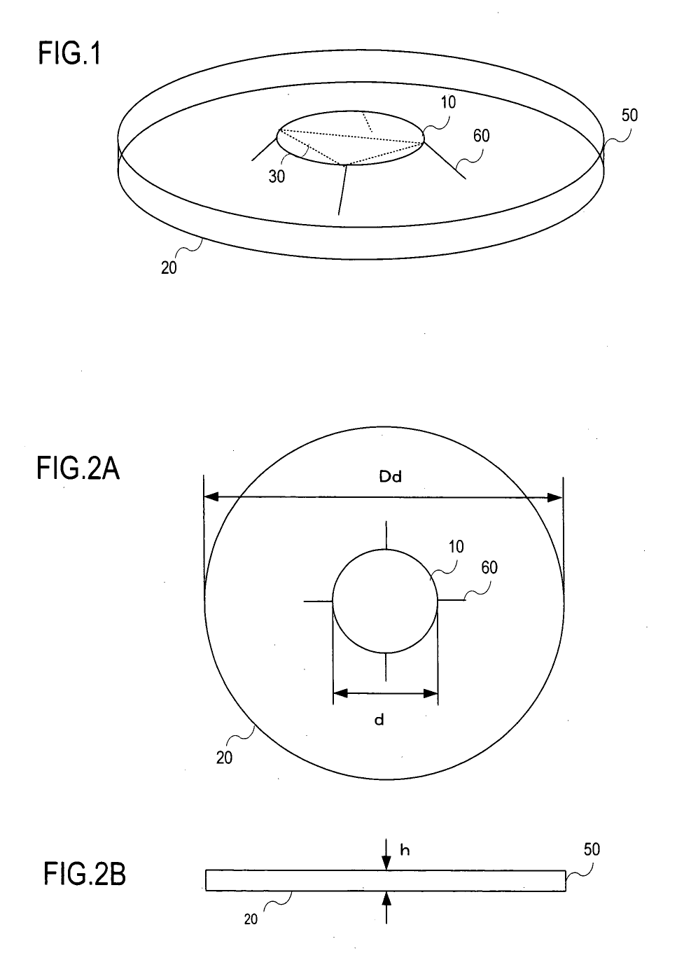

Furthermore, according to the capacity loaded planar antenna with the short stubs of the embodiment of the present invention, in the above constitution, the short stubs are formed integrally with the antenna element, and have a foldable plate-like shape, which can simplify the constitution to facilitate manufacturing.

[Constitution of the Present Antenna: FIGS. 1 and 2]

The constitution of the capacity loaded planar antenna with the short stubs according to the embodiment of the present invention (the present antenna) will be described with reference to FIGS. 1 and 2. FIG. 1 is a schematic constitution diagram of the capacity loaded planar antenna with the short stubs according to the embodiment of the present invention, and FIG. 2A is a plan view, and FIG. 2B is a side view.

As shown in FIGS. 1 and 2, the present antenna comprises an antenna element 10, a base plate 20, a support plate 30, a side wall 50 and short pins (short stubs) 60.

[Respective Components]

The antenna element 10, the base plate 20 and the support plate 30 have a constitution similar to a conventional constitution. It is to be noted that the antenna element 10 and the base plate 20 have a disc-like shape, but may have a regular polygonal shape.

[Side Wall 50]

The side wall 50 is formed in a vertical direction along the end portion of the periphery of the base plate 20.

The optimum height of the side wall 50 depends on a size (a diameter) Dd of the base plate 20. For example, in case of Dd=160 mm, a high bandwidth is acquired in a range of the height of the side wall 50 ho<0.17λ (λ: a wavelength), and when ho=0.13λ, a maximum value of 32.4% of the bandwidth can be realized.

It is to be noted that a thickness of the side wall 50 is to be about 1 mm, but the thickness is not limited to this example.

Moreover, in another example, when a diameter d of the antenna element 10 is 0.360λ and a diameter Dd of the base plate 20 is 1.067λ, a height h of the side wall 50 may be set to 0.067λ.

[Short Pin 60]

Unlike conventional posts 40, the short pins (the short stubs) 60 are not installed in a vertical direction with respect to the base plate 20, but as shown in FIG. 1, fine pins which connect the antenna element 10 to the base plate 20 are disposed in an oblique direction with respect to the base plate 20.

The length of the short pins 60 can be varied, whereby a resonance frequency can be varied, and the antenna can be tuned to a plurality of frequencies.

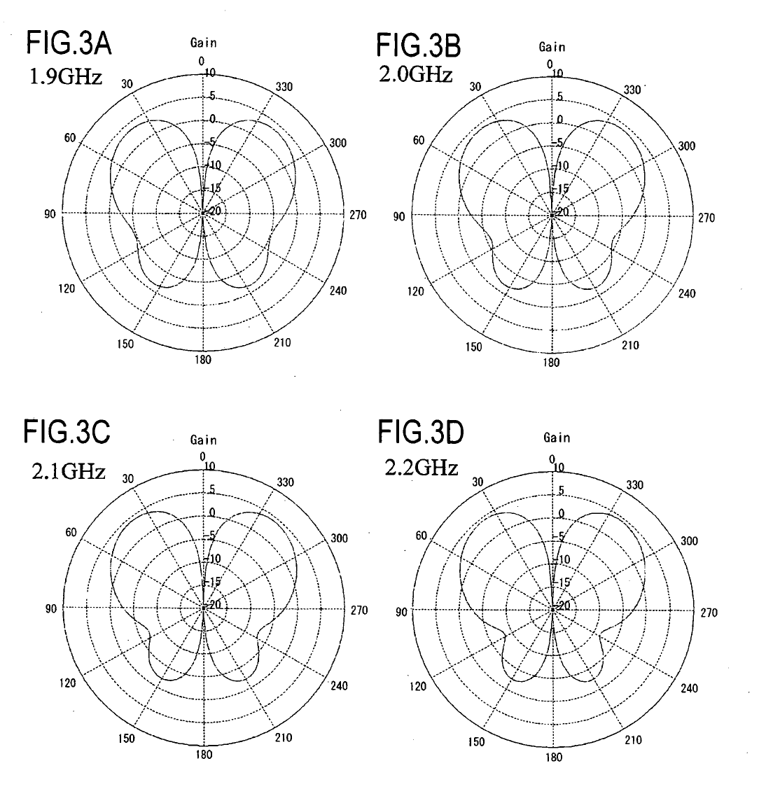

Moreover, the shape of the short pins 60 is not limited to a linear shape, but may be a curved shape, and the shape is not limited to the fine pin shape, but may be a strip-like shape.

[Vertical Plane Radiation Directivity: FIG. 3]

The vertical plane radiation directivity of the present antenna will be described with reference to FIG. 3. FIG. 3 is a diagram showing the vertical plane radiation directivity of the present antenna. FIG. 3 shows directivities at 1.9 GHz (FIG. 3A), 2.0 GHz (FIG. 3B), 2.1 GHz (FIG. 3C) and 2.2 GHz (FIG. 3D).

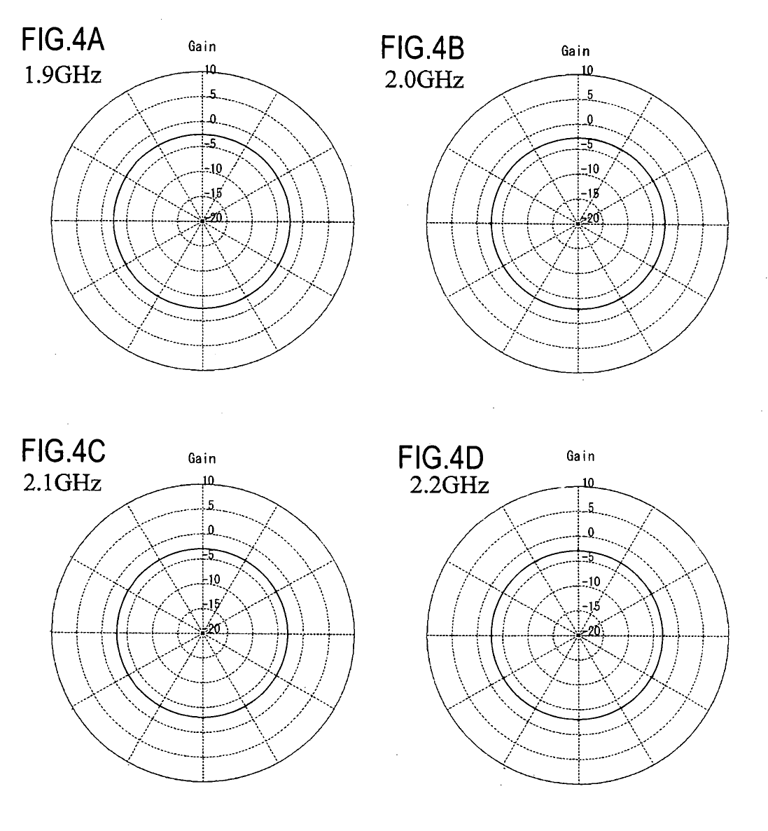

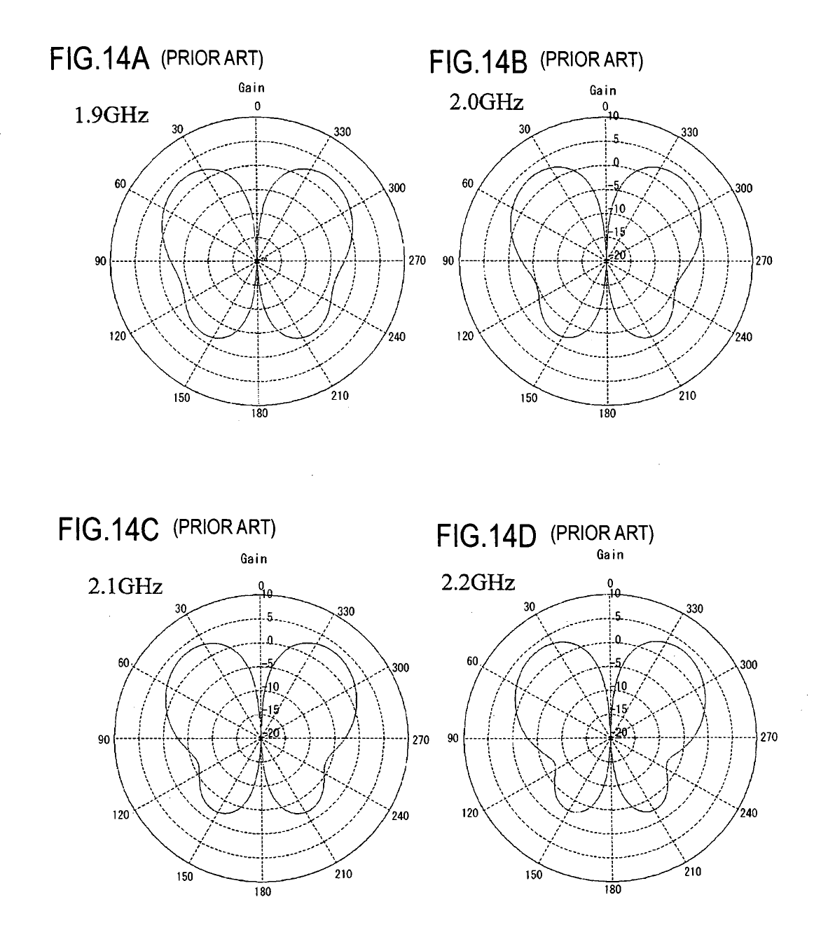

In the vertical plane radiation directivity of the present antenna, as shown in FIG. 3, a directivity pattern basically does not considerably change, but a gain rises as much as about 1 dB, as compared with the vertical plane radiation directivity of the conventional antenna of FIG. 14.

[Horizontal Plane Radiation Directivity: FIG. 4]

The horizontal plane radiation directivity of the present antenna will be described with reference to FIG. 4. FIG. 4 is a diagram showing the horizontal plane radiation directivity of the present antenna. FIG. 4 shows directivities at 1.9 GHz (FIG. 4A), 2.0 GHz (FIG. 4B), 2.1 GHz (FIG. 4C) and 2.2 GHz (FIG. 4D).

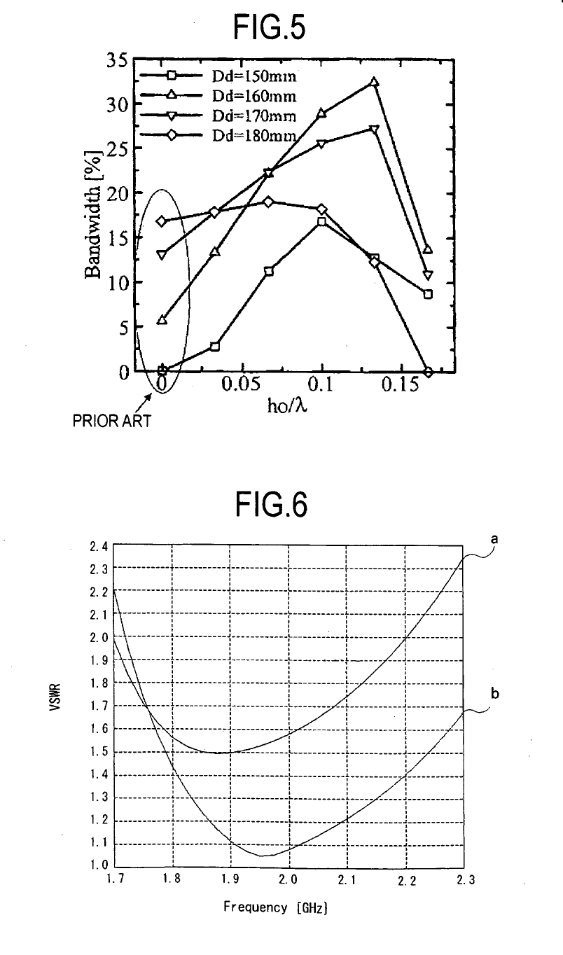

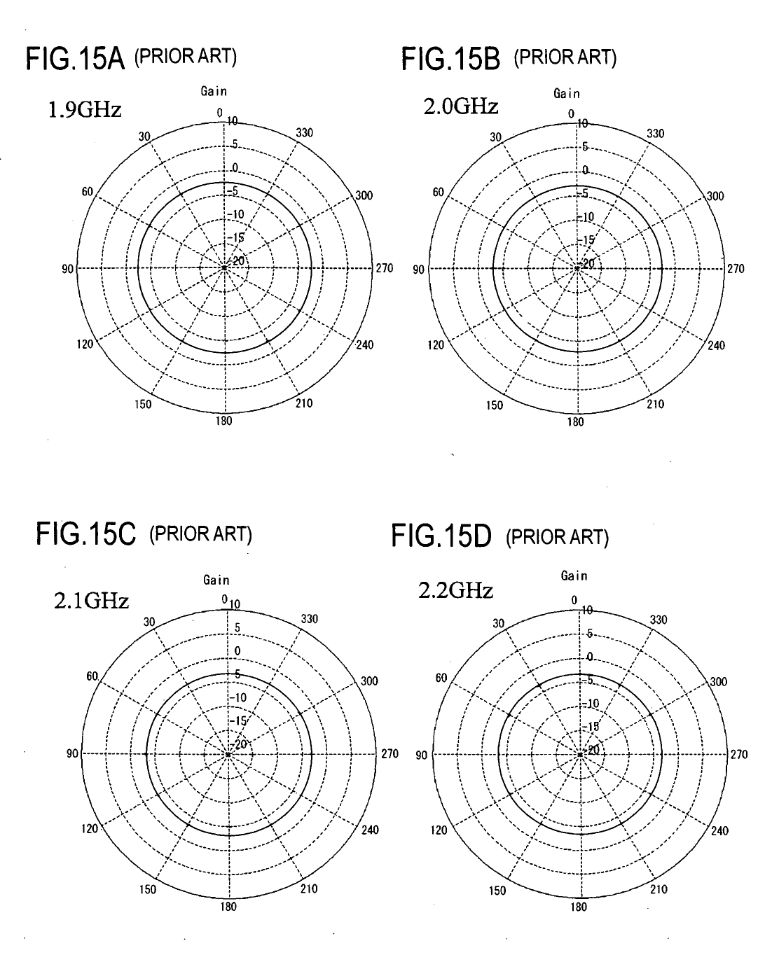

In the horizontal plane radiation directivity of the present antenna, as shown in FIG. 4, a directivity pattern basically does not considerably change, as compared with the horizontal plane radiation directivity of the conventional antenna of FIG. 15.

[Bandwidth When Height of Side Wall Varies: FIG. 5]

Next, the bandwidth when the height of the side wall varies will be described with reference to FIG. 5. FIG. 5 is a diagram showing the bandwidth of VSWR<1.5 when the height of the side wall varies.

In FIG. 5, the ordinate indicates a bandwidth [%], the abscissa indicates a side wall height (ho/λ), and this graph shows four bandwidths when a diameter Dd of the base plate 20 is 150, 160, 170 and 180 mm.

That is, in FIG. 5, ho/λ=0 (the left end) indicates a side wall height of zero, and the height increases toward the right.

As shown in FIG. 5, it is seen that when Dd=160 mm or 170 mm, a high ratio of the bandwidth can be obtained approximately in a range of 0.1<ho/λ<0.15. When the height of the side wall 50 is adequately set in accordance with the size of the base plate 20, a wide bandwidth can be obtained.

[VSWR When Length of Short Stubs Can be Varied: FIG. 6]

Next, the VSWR when the length of the short stubs can be varied will be described with reference to FIG. 6. FIG. 6 is a diagram showing the VSWR when the length of the short stubs can be varied. In FIG. 6, the ordinate indicates the VSWR, and the abscissa indicates a frequency [GHz].

It is to be noted that a curve a in FIG. 6 shows a case where the present antenna includes the side wall 50 and the short pins 60 are disposed vertically to the base plate 20, and in this example, a distance in a vertical direction is set to 14 mm and a length of the short pins 60 is set to 14 mm. A curve b shows a case where the present antenna includes the side wall 50, and the short pins 60 are obliquely connected to the base plate 20. That is, the curve b shows a short pin example where the distance in the vertical direction is set to 14 mm, and a connection point of the short pin 60 connected to the end portion of the antenna element 10 is connected to a point which is horizontally 6 mm away from a point of the base plate 20 disposed vertically downwardly from the connection point.

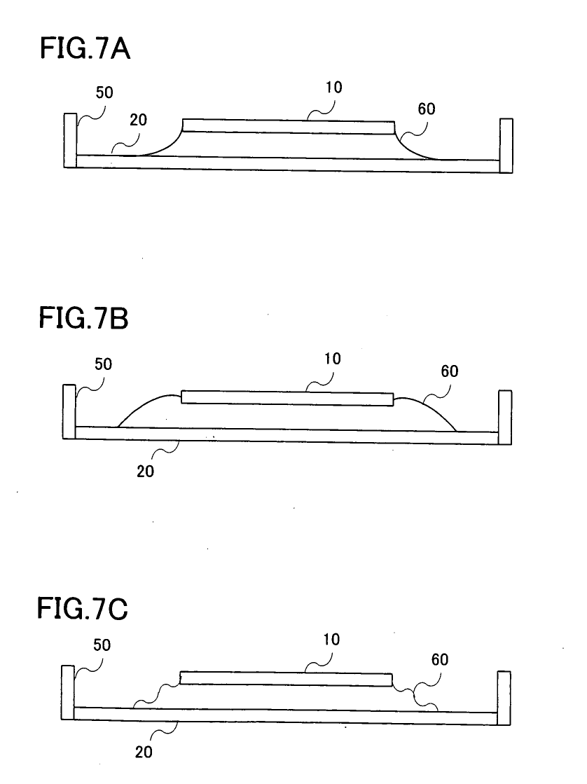

As seen from FIG. 6, when the side wall 50 is disposed, a band becomes wider in a constitution in which the short pins 60 are obliquely connected to the base plate 20 as compared with a constitution in which the short pins 60 are vertically connected in the same manner as in conventional posts.

[Shape of Short Stubs: FIG. 7]

Next, the shape of the short stubs will be described with reference to FIG. 7. FIG. 7 is a diagram showing three examples of a constitution of the short stubs.

FIG. 7A shows an example where the short stubs have a concave curve shape with respect to the base plate 20. FIG. 7B shows an example where the short stubs have a convex curve shape with respect to the base plate 20. FIG. 7C shows an example where the short stubs have a wavy line shape.

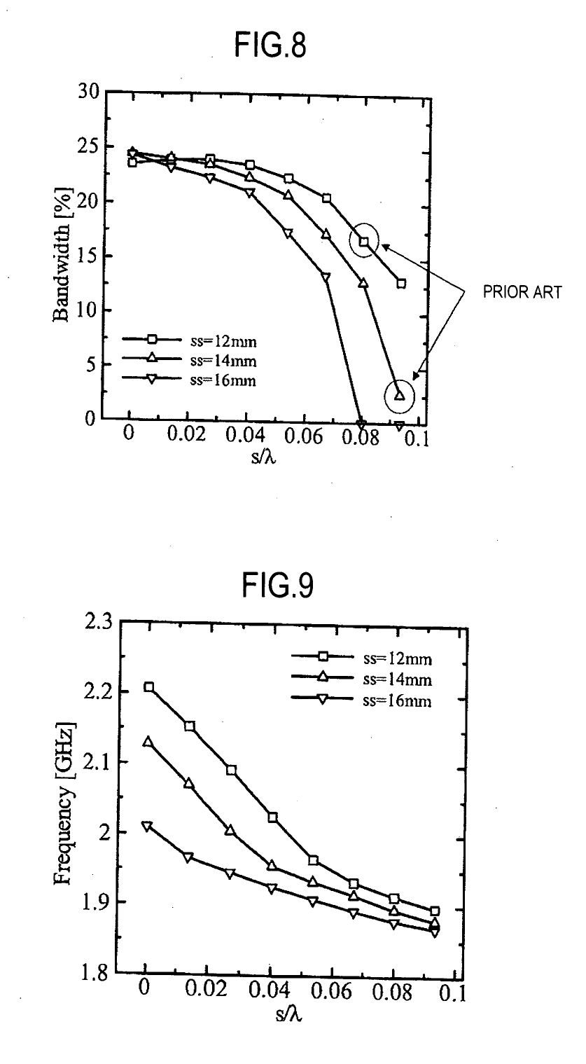

In consequence, unlike a case where the short stubs (the short pins) are vertically connected to the base plate 20, a wider bandwidth can be acquired by obliquely connecting the linear or curved short stubs.

[Bandwidth When Length of Short Stubs Can be Varied: FIG. 8]

Next, the bandwidth when the length of the short stubs can be varied will be described with reference to FIG. 8. FIG. 8 is a diagram showing the bandwidth of VSWR<1.5 when the length of the short stubs can be varied. In FIG. 8, the ordinate indicates a bandwidth [%], and the abscissa indicates a length s of the short stubs by s/λ.

It is to be noted that FIG. 8 shows bandwidths when the length s of the short stubs is shortened in a case where a distance ss in the vertical direction between the antenna element 10 and the base plate 20 arranged in parallel is set to 12 mm, 14 mm and 16 mm. Therefore, the right end of FIG. 8 shows s=ss (the conventional technology).

It is seen that a satisfactory bandwidth can be obtained approximately in a range of s/λ of 0 to 0.06.

For example, in the case of the distance ss=14 mm, the bandwidth of VSWR<1.5 is 2.6% in the conventional constitution, whereas the wider bandwidth can be acquired in a range of s<0.09λ and a maximum value of 24.5% can be realized when s=0.

[Resonance Frequency When Length of Short Stubs Can be Varied: FIG. 9]

Moreover, the resonance frequency when the length of the short stubs can be varied will be described with reference to FIG. 9. FIG. 9 is a diagram showing the resonance frequency when the length of the short stubs can be varied. In FIG. 9, the ordinate indicates the frequency [GHz], and the abscissa indicates the length s of the short stubs by s/λ.

Furthermore, FIG. 9 shows frequency characteristics when the length s of the short stubs is shortened in a case where the distance ss in the vertical direction between the antenna element 10 and the base plate 20 arranged in parallel is set to 12 mm, 14 mm and 16 mm.

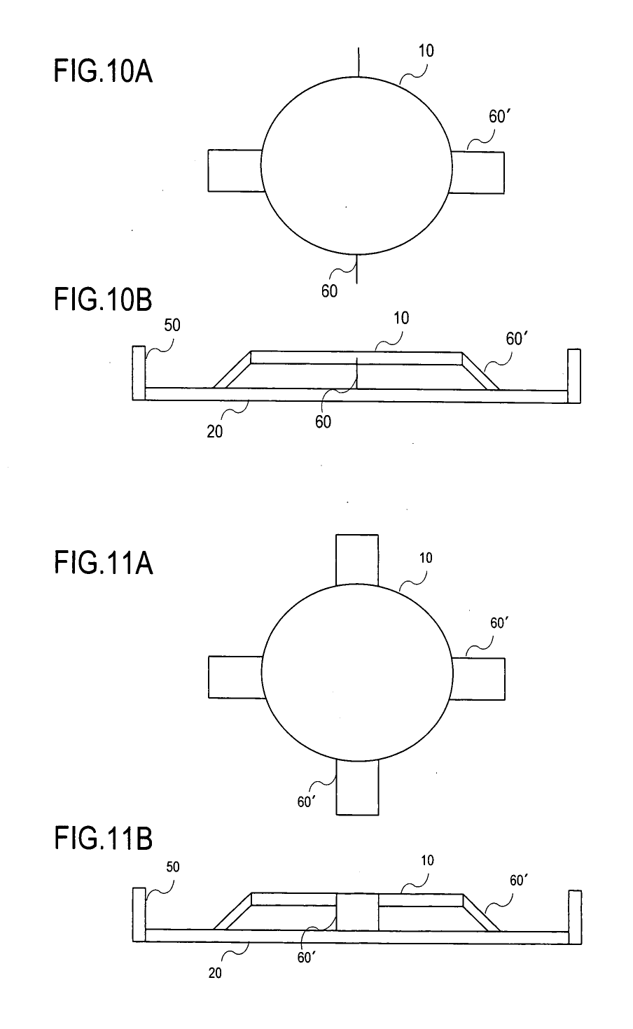

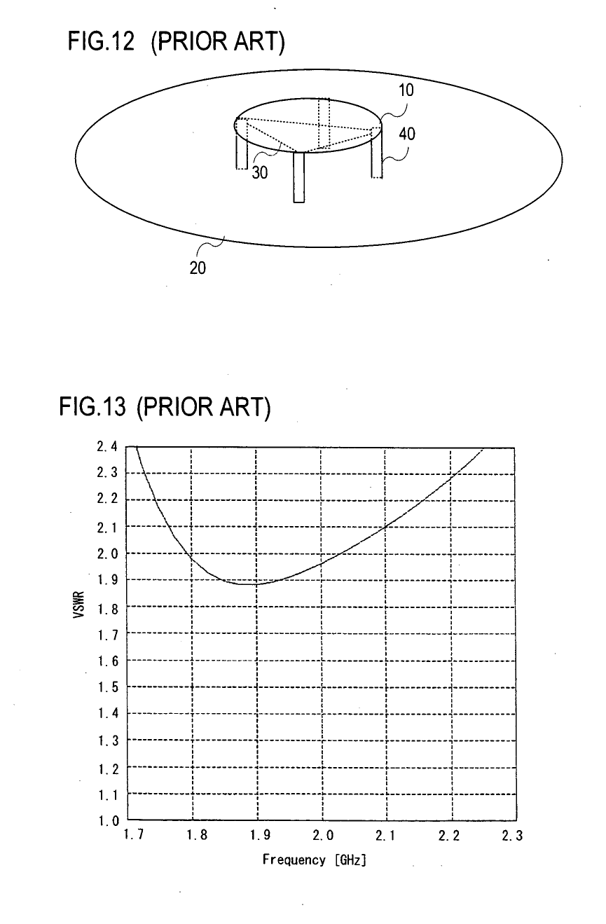

It is seen that satisfactory frequency characteristics are obtained approximately in a range of s/λ of 0 to 0.04.

[Another Shape 1 of Short Stubs: FIG. 10]

Another shape of the short stubs will be described with reference to FIG. 10. FIG. 10 is a diagram showing another shape 1 of the short stubs. It is to be noted that FIG. 10A shows a plan view, and FIG. 10B shows a side view.

As shown in FIG. 10A, one set of facing short stubs are formed as a plate-like short stub 60′ integrally with the antenna element 10. Subsequently, boundary portions between the antenna element 10 and the plate-like short stub 60′ are bent toward a base plate 20 side, the antenna element 10 is installed on the base plate 20, and then the short pins 60 are formed.

In consequence, the plate-like short stub 60′ is formed integrally with the antenna element 10, which can facilitate attaching of the antenna element 10 to the base plate 20.

[Still Another Shape 2 of Short Stubs: FIG. 11]

Furthermore, the short stubs may have a constitution shown in FIG. 11. FIG. 11 is a diagram showing still another shape 2 of the short stubs. It is to be noted that FIG. 11A shows a plan view, and FIG. 11B shows a side view.

As shown in FIG. 11A, all the short stubs are formed as plate-like short stubs 60′ integrally with the antenna element 10. Moreover, boundary portions between the antenna element 10 and the plate-like short stubs 60′ are bent toward the base plate 20 side, and the antenna element 10 is installed on the base plate 20.

In consequence, the plate-like short stubs 60′ are formed integrally with the antenna element 10, which can facilitate the attaching of the antenna element 10 to the base plate 20.

### Effect of the Embodiment

The present antenna includes the plurality of short stubs 60 which connect the antenna element 10 to the base plate 20, and the side wall 50 formed along the end portion of the base plate 20, which produces an effect that a small size and a low posture can be acquired, and a wider bandwidth can be realized.

Moreover, according to the present antenna, since the length of the short stubs 60 can be varied, there is produced an effect that the resonance frequency can be varied, and the antenna can be tuned to a plurality of frequencies.

Furthermore, according to the present antenna, since the short stubs are formed integrally with the antenna element 10 as the foldable plate-like short stub 60′, there is produced an effect that the constitution can be simplified to facilitate manufacturing.

The present invention is suitable for a capacity loaded planar antenna with short stubs which can acquire a small size and a low posture, can realize a wider bandwidth and can be tuned to a plurality of frequencies.

What is claimed is:

1. A capacity loaded planar antenna with short stubs, comprising: a base plate; an antenna element disposed in parallel with the base plate; a plurality of short stubs which connect the antenna element to the base plate; and a side wall formed along the end portion of the base plate.

2. The capacity loaded planar antenna with the short stubs according to claim 1, wherein a length of the short stubs is varied to vary a resonance frequency.

3. The capacity loaded planar antenna with the short stubs according to claim 1, wherein the short stubs are formed integrally with the antenna element, and have a foldable plate-like shape.

4. The capacity loaded planar antenna with the short stubs according to claim 2, wherein the short stubs are formed integrally with the antenna element, and have a foldable plate-like shape.

5. The capacity loaded planar antenna with the short stubs according to claim 1, wherein the short stubs which connect the antenna element to the base plate are disposed in an oblique direction, and the short stubs have a linear or curved shape, and have a pin-like or strip-like shape.

6. The capacity loaded planar antenna with the short stubs according to claim 2, wherein the short stubs which connect the antenna element to the base plate are disposed in an oblique direction, and the short stubs have a linear or curved shape, and have a pin-like or strip-like shape.

7. The capacity loaded planar antenna with the short stubs according to claim 1, wherein when a diameter of the base plate is set to 160 mm, a height of the side wall is set to 0.13λ (a wavelength).

8. The capacity loaded planar antenna with the short stubs according to claim 1, wherein when a diameter of the base plate is set to 160 mm or 170 mm, a value obtained by dividing a height of the side wall by a wavelength λ is larger than 0.1 and smaller than 0.15.

9. The capacity loaded planar antenna with the short stubs according to claim 1, wherein the value obtained by dividing the length of the short stubs by the wavelength λ is in a range of 0 to 0.06.

10. The capacity loaded planar antenna with the short stubs according to claim 2, wherein the value obtained by dividing the length of the short stubs by the wavelength λ is in a range of 0 to 0.06.

11. The capacity loaded planar antenna with the short stubs according to claim 3, wherein the value obtained by dividing the length of the short stubs by the wavelength λ is in a range of 0 to 0.06.

12. The capacity loaded planar antenna with the short stubs according to claim 1, wherein the value obtained by dividing the length of the short stubs by the wavelength λ is in a range of 0 to 0.04.

13. The capacity loaded planar antenna with the short stubs according to claim 2, wherein the value obtained by dividing the length of the short stubs by the wavelength λ is in a range of 0 to 0.04.

14. The capacity loaded planar antenna with the short stubs according to claim 3, wherein the value obtained by dividing the length of the short stubs by the wavelength λ is in a range of 0 to 0.04.

15. The capacity loaded planar antenna with the short stubs according to claim 3, wherein one set of short stubs facing the antenna element are formed integrally with the antenna element, and the other short stubs are formed in the form of short pins.

16. The capacity loaded planar antenna with the short stubs according to claim 4, wherein one set of short stubs facing the antenna element are formed integrally with the antenna element, and the other short stubs are formed in the form of short pins.

17. The capacity loaded planar antenna with the short stubs according to claim 1, wherein the antenna element and the base plate have a disc-like or regular polygonal shape.

18. The capacity loaded planar antenna with the short stubs according to claim 2, wherein the antenna element and the base plate have a disc-like or regular polygonal shape.

19. The capacity loaded planar antenna with the short stubs according to claim 3, wherein the antenna element and the base plate have a disc-like or regular polygonal shape.
